(19) United States
(12) Patent Application Publication
(10) Pub. No.: US 2018/0032973 A1
(43) Pub. Date: Feb. 1, 2018

(54) METHOD OF SWAPPING CARD ACCOUNTS USED IN A FINANCIAL TRANSACTION

(71) Applicant: MasterCard International Incorporated, Purchase, NY (US)

(72) Inventors: Piyush Sharma, Pune (IN); Elson Rodrigues, Mumbai (IN)

(21) Appl. No.: 15/655,026

(22) Filed: Jul. 20, 2017

(30) Foreign Application Priority Data
Aug. 1, 2016 (SG) 10201606326V

(51) Int. Cl. G06Q 20/04; G06Q 30/06; G06Q 20/38

(52) U.S. Cl. CPC G06Q 20/04; G06Q 20/382; G06Q 30/06

(57) ABSTRACT

A method of swapping card accounts used in a financial transaction comprises generating an authorisation code in response to receipt of a request for card accounts to be swapped, the request comprising data indicative of a transacting card account used to fund the financial transaction, transmitting the authorisation code, receiving data indicative of a supplied card account used to initiate the financial transaction along with the authorisation code, the supplied card account serving as a placeholder for the transacting card account, swapping the data indicative of the supplied card account with data indicative of the transacting card account, in response to receipt of the received data and transmitting the data indicative of the transacting card account to effect the transfer of funds at the transacting card account.

### CROSS-REFERENCE TO RELATED APPLICATION

This application is a U.S. National Stage filing under 35 U.S.C. §119, based on and claiming benefit of and priority to SG Patent Application No. 10201606326V filed Aug. 1, 2016.

### TECHNICAL FIELD

Various embodiments relate to a method of swapping card accounts used in a financial transaction.

### BACKGROUND ART

Payment cards such as credit cards, debit cards and automated teller machine (ATM) cards are often used in consumer financial transactions. Consumer financial transactions include payment at point-of-sale (POS) terminals, deposit or withdrawal of funds at ATMs, credit card cash advances and crediting or debiting of financial accounts.

Consumers usually own one or more payment cards, which are generally issued/provided by one or more issuers. The consumers may have a preference for using relevant/specific payment cards for certain financial transactions. However, each of the payment cards is usually linked to only one payment account, and it is often necessary for the consumers to present the relevant/specific payment card at the time of transaction. This poses an inconvenience for the consumers who may not be able to present the desired/relevant payment card at the point of transaction.

There may also be occasions when the consumers may also wish to use a payment card that is not presently on hand, as the payment card they supplied for the financial transaction at a transaction terminal has reached a credit limit, or has zero debit balance. There may also be situations when the consumers are unwilling to present a specific payment card they wish to use for the financial transaction due to security concerns, and would prefer to present another payment card instead.

Accordingly, there is a need to address some of the above problems. Furthermore, other desirable features and characteristics will become apparent from the subsequent detailed description and the appended claims, taken in conjunction with the accompanying drawings and this background of the disclosure.

### SUMMARY OF INVENTION

A first aspect of the present invention provides a method of swapping card accounts used in a financial transaction. The method comprises generating an authorisation code in response to receipt of a request for card accounts to be swapped, the request comprising data indicative of a transacting card account used to fund the financial transaction, transmitting the authorisation code, receiving data indicative of a supplied card account used to initiate the financial transaction along with the authorisation code, the supplied card account serving as a placeholder for the transacting card account, swapping the data indicative of the supplied card account with data indicative of the transacting card account, in response to receipt of the received data and transmitting the data indicative of the transacting card account to effect the transfer of funds at the transacting card account.

The method may further comprise receiving a message indicative of an authorisation of the transfer of funds at the transacting card account, and forwarding the message indicative of the authorisation of the transfer of funds at the transacting card account together with data indicative of the supplied card account.

The supplied card account and the transacting card account may belong to a plurality of card accounts accessible in a mobile application to which the authorisation code is transmitted.

The step of receiving the data indicative of the supplied card account used to initiate the financial transaction may comprise receiving a verification code used to authenticate the supplied card account.

The swapping of the data and the transmission of the data indicative of the transacting card account to effect the transfer of funds at the transacting card account may occur after successful verification of the authorisation code. The step of receiving the verification code may further comprise, upon unsuccessful verification of the authorisation code, determining if the verification code is received, and transmitting the data indicative of the supplied card account to effect the transfer of funds at the supplied card account in response to receipt of the verification code.

The transfer of funds at the transacting card account may comprise crediting or debiting of the transacting card account.

The step of generating the authorisation code, the step of transmitting the authorisation code and the step of swapping the data indicative of the supplied card account with the data indicative of the transacting card account may be performed by a payment network server.

The step of generating the authorisation code, the step of transmitting the authorisation code and the step of swapping the data indicative of the supplied card account with the data indicative of the transacting card account may be performed alternatively by a card account swapping server.

The method may further comprise the steps of transmitting a message indicative of failure to effect the transfer of funds at the transacting card account, and prompting for a selection of an alternate transacting card account.

A second aspect of the present invention provides a method of facilitating the swapping of card accounts used in a financial transaction. The method comprises analysing received data indicative of a supplied card account used to initiate the financial transaction for presence of an authorisation code, said authorisation code being indicative of the supplied card account to be replaced with a transacting card account used for funding the financial transaction, transmitting the received data indicative of the supplied card account to a card account swapping server in response to presence of the authorisation code, receiving data indicative of the transacting card account from the card account swapping server, and transmitting the data indicative of the transacting card account to a server administering the transacting card account.

The method may further comprise receiving, from the server administering the transacting card account, a message indicative of an authorisation of the transfer of funds at the transacting card account, and forwarding, to an acquirer from which the data indicative of the supplied card account used to initiate the financial transaction is received, the message indicative of the authorisation of the transfer of funds at the transacting card account together with data indicative of the supplied card account.

The step of analysing received data indicative of the supplied card account used to initiate the financial transaction may comprise receiving a verification code used to authenticate the supplied card account.

The transmission of the received data indicative of the supplied card account to the card account swapping server may occur after successful verification of the authorisation code. The step of receiving the verification code may further comprise, upon unsuccessful verification of the authorisation code, determining if the verification code is received, and transmitting the data indicative of the supplied card account to effect the transfer of funds at the supplied card account in response to receipt of the verification code.

The transfer of funds at the transacting card account may comprise crediting or debiting of the transacting card account.

The method may further comprise the steps of transmitting a message indicative of failure to effect the transfer of funds at the transacting card account, and prompting for a selection of another transacting card account.

A third aspect of the present invention provides an account swapping system configured to administer the swapping of card accounts used in a financial transaction. The account swapping system comprises at least one processor, and at least one memory including computer program code. The at least one memory and the computer program code are configured to, with the at least one processor, cause the account swapping system at least to generate an authorisation code in response to receipt of a request for card accounts to be swapped, the request comprising data indicative of a transacting card account used to fund the financial transaction, transmit the authorisation code, receive data indicative of a supplied card account used to initiate the financial transaction along with the authorisation code, the supplied card account serving as a placeholder for the transacting card account, swap the data indicative of the supplied card account with data indicative of the transacting card account, in response to receipt of the received data, and transmit the data indicative of the transacting card account to effect the transfer of funds at the transacting card account.

The account swapping system may be further configured to receive a message indicative of an authorisation of the transfer of funds at the transacting card account and forward the message indicative of the authorisation of the transfer of funds at the transacting card account together with data indicative of the supplied card account.

The account swapping system may be further configured to receive a verification code used to authenticate the supplied card account.

The account swapping system may be configured to swap the received data indicative of the supplied card account with the data indicative of the transacting card account and transmit the data indicative of the transacting card account after successful verification of the authorisation code. The account swapping system may be further configured to, upon unsuccessful verification of the authorisation code, determine if the verification code is received, and transmit the data indicative of the supplied card account to effect the transfer of funds at the supplied card account in response to receipt of the verification code.

A fourth aspect of the present invention provides a payment network server configured to facilitate the swapping of card accounts used in a financial transaction. The payment network server comprises at least one processor and at least one memory including computer program code. The at least one memory and the computer program code are configured to, with the at least one processor, cause the payment network server at least to analyse received data indicative of a supplied card account used to initiate the financial transaction for presence of an authorisation code, said authorisation code being indicative of the supplied card account to be replaced with a transacting card account used to fund the financial transaction, transmit the received data indicative of the supplied card account to a card account swapping server in response to presence of the authorisation code, receive data indicative of the transacting card account from the card account swapping server and transmit the data indicative of the transacting card account to a server administering the transacting card account.

The payment network server may be further configured to receive, from the server administering the transacting card account, a message indicative of an authorisation of the transfer of funds at the transacting card account, and forward, to an acquirer from which the data indicative of the supplied card account used to initiate the financial transaction is received, the message indicative of the authorisation of the transfer of funds at the transacting card account together with data indicative of the supplied card account.

The payment network server may be configured to receive a verification code used to authenticate the supplied card account.

The payment network server may be configured to transmit the data indicative of the transacting card account after successful verification of the authorisation code. The payment network server may be further configured to, upon unsuccessful verification of the authorisation code, determine if the verification code is received, and transmit the data indicative of the supplied card account to effect the transfer of funds at the supplied card account in response to receipt of the verification code.

A fifth aspect of the present invention provides a non-transitory computer readable medium having stored thereon an application which when executed by a computer causes the computer to perform steps comprising generating an authorisation code in response to receipt of a request for card accounts to be swapped, the request comprising data indicative of a transacting card account used to fund the financial transaction, transmitting the authorisation code, receiving data indicative of a supplied card account used to initiate the financial transaction along with the authorisation code, the supplied card account serving as a placeholder for the transacting card account, swapping the data indicative of the supplied card account with data indicative of the transacting card account, in response to receipt of the received data, and transmitting the data indicative of the transacting card account to effect the transfer of funds at the transacting card account.

A sixth aspect of the present invention provides a non-transitory computer readable medium having stored thereon an application which when executed by a computer causes the computer to perform steps comprising analysing received data indicative of a supplied card account used to initiate the financial transaction for presence of an authorisation code, said authorisation code being indicative of the supplied card account to be replaced with a transacting card account used for funding the financial transaction transmitting the received data indicative of the supplied card account to a card account swapping server in response to presence of the authorisation code, receiving data indicative of the transacting card account from the card account swapping server, and transmitting the data indicative of the transacting card account to a server administering the transacting card account.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1

FIG. 1 shows a schematic diagram of a transaction system in which card accounts are swapped, in accordance with embodiments of the invention.

FIG. 2

FIG. 2 shows a flowchart illustrating a method of swapping card accounts used in a financial transaction, in accordance with a first embodiment of the invention and implemented in the system of FIG. 1.

FIG. 3

FIG. 3 shows a flowchart illustrating a method of facilitating the swapping of card accounts used in a financial transaction, in accordance with a second embodiment of the invention and implemented in the system of FIG. 1.

FIG. 4

FIG. 4 shows a schematic of a computing device used to realise the transaction system shown in FIG. 1.

### DESCRIPTION OF EMBODIMENTS

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units.

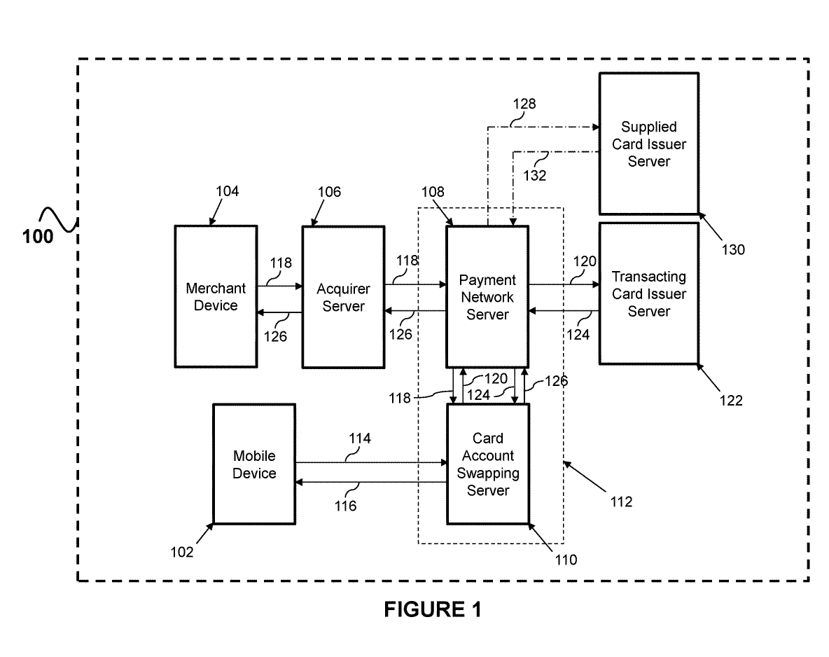

FIG. 1 shows a schematic diagram of a transaction system 100 which allows card accounts to be swapped, according to embodiments of the invention. The transaction system 100 advantageously allows consumers to designate a card account that eventually funds a transaction, where the designated card account is different from the card account used to initiate the transaction. In embodiments of the invention, this designated card account that funds the transaction is referred to as a “transacting card account”, while the card account used to initiate the transaction is referred to as a “supplied card account”. The transacting card account is different from the supplied card account. The benefit is achieved by swapping data indicative of the supplied card account e.g. primary account number (PAN) block of the supplied card account with data indicative of the transacting card account e.g. PAN block of the transacting card account as the transaction is routed through the transaction system 100. Data indicative of the supplied card account and data indicative of the transacting card account refers to data which allows the transaction request to be routed to the correct issuer and also includes data related to the financial transaction. Accordingly, embodiments of the invention allow the consumer to access one or more card accounts while providing a single payment card, and grant the consumer flexibility in use of different card accounts for various types of transactions with a single payment card.

The transaction system 100 comprises a mobile device 102, a merchant device 104, an acquirer server 106, an account swapping system 112, and a transacting card issuer server 110. The transaction system 100 may also optionally include a supplied card issuer server 130. The mobile device 102 is in direct communication with the account swapping system 112. The merchant device 104 is in direct communication with the acquirer server 106 which is in turn in direct communication with the account swapping system 112. The transacting card issuer server 110 is also in direct communication with the account swapping system 112.

The mobile device 102 is typically associated with a consumer who initiates a financial transaction at the merchant device 104. The mobile device 102 may be, for example, a mobile terminal such as a laptop computer, smartphone, smartwatch or a tablet with an advanced mobile operating system, such as Windows of Microsoft, iOS of Apple Inc. or Android of Google Inc. The operating system may host one or more mobile applications, where the one or more mobile applications includes a card account management application which the consumer uses to initiate a request for a swap of card accounts used in the financial transaction. In other words, the consumer may designate the supplied card account and the transacting card account used in a financial transaction from a plurality of card accounts accessible in the one or more mobile applications on the mobile device 102.

The merchant device 104 is typically associated with a merchant who is also a party to the financial transaction. The merchant device 104 is also commonly known as a transaction acquiring device, and may be a point-of-sale (POS) terminal, or an automated teller machine (ATM) and the like, to which the consumer presents a supplied payment card (i.e. a payment card linked to the supplied card account) used to initiate the financial transaction.

The acquirer server 106 is typically associated with an acquirer who may be an entity (e.g. a company or organization) which provides and administers an account (e.g. a financial bank account) of the merchant. Examples of the acquirer include a bank and/or other financial institution. As mentioned above, the acquirer server 106 may include one or more computing devices that are used to establish communication with another server by exchanging messages with and/or passing information to the other server.

The account swapping system 112 is typically associated with a payment facilitator. In a first embodiment of the invention, the account swapping system 112 is implemented as a network of interconnected computing devices (namely a payment network server 108 and a card account swapping server 112) which operate together to perform the roles of a payment network and a card account swapping network. The account swapping system 112 comprises a payment network server 108 and a card account swapping server 110, where each of the servers 108, 110 may represent a single computing device or a network of interconnected computing devices which operate together to perform the roles of a payment network and a card account swapping network respectively. In a second embodiment of the invention, the account swapping system 112 may be a single computing device (depicted using the dotted box shown in FIG. 1) that performs both payment network and card account swapping roles.

The account swapping system 112 may be operated by a payment facilitator. For example, the account swapping system 112 may be a Banknet network operated by the payment facilitator (e.g. MasterCard) which may be an entity (e.g. a company or organization) that operates to process transactions, clear and settle funds for payments between two other entities (e.g. two banks). For example, the account swapping system 112 may be one or more computing devices configured to implement the four party model used by the payment facilitator (e.g. MasterCard) to process the financial transaction. The account swapping system 112 routes information between the acquirer server 106 and the transacting card issuer server 122.

The card account swapping server 110 may be configured to swap the data indicative of the supplied card account with the data indicative of the transacting card account as the transaction is routed through the transaction system 100. Further, data associated with the plurality of card accounts may be stored on a database linked to the card account swapping server 112. The card account swapping server 112 may also be known as a mobile application server in this regard. In one implementation, the card account swapping server 110 is configured to generate and transmit an authorisation code in response to receiving a request to swap card accounts. Such a request occurs when the mobile device 112 indicates that while a card account is used to initiate a financial transaction (the supplied card account), a different card account is designated to fund the financial transaction (the transacting card account), whereby the card account swapping server 112 will effect the process of swapping data indicative of the supplied card account with data indicative of the transacting card account. The authorisation code thus serves as an indicator that such a data swapping process is requested. Recipients which recognise this authorisation code are configured to route financial transaction data paired with the authorisation code, back to the card account swapping server 110 to perform the account data swap.

The transacting card issuer server 122 is generally associated with a transacting card issuer, i.e. the issuer of the card account designated to fund the financial transaction after the card account data swap. The transacting card issuer server 122 may include one or more computing devices that are used to process funding of the financial transaction. The transacting card issuer may be an entity (e.g. a company or organisation) which issues (e.g. establishes, manages, administers) a card account (e.g. a credit card account, a stored value card, or a debit card account linked to a bank account).

The supplied card issuer server 130 is generally associated with a supplied card issuer, i.e. the issuer of the card account used to initiate the financial transaction. The supplied card issuer server 130 may similarly include one or more computing devices that are used to support the transaction system 100 operating in the card account data swap mode. These supplied card issuer server 130 is able to process funding of the financial transaction when the card account used to initiate the financial transaction is also used to fund the financial transaction, i.e. no card account data swap occurs. The supplied card issuer may be an entity (e.g. a company or organisation) separate from the transacting card issuer but similarly issues (e.g. establishes, manages, administers) a card account (e.g. a credit card account, a stored value card, or a debit card account linked to a bank account).

A financial transaction includes several stages that occur to cause a transfer of funds (such as crediting or debiting) to occur at a card account. In the context of the transaction system 100, a first stage has a financial transaction being initiated by using a payment card to make a purchase, typically at the merchant device 104. Data routed within the transaction system 100 to have the purchase billed against a card account falls under the funding stage of the financial transaction. The destination of the purchase data is typically either the transacting card issuer server 122 or the supplied card issuer server 130. Data which indicates the successful billing of the card account, transmitted from either the transacting card issuer server 122 or the supplied card issuer server 130, falls under the acknowledgement stage of the financial transaction.

Prior to initiation of a financial transaction at the merchant device 104, the consumer may decide that a payment card different from the one he uses to initiate the financial transaction is to be used for the financial transaction. Such a decision may be reached because the consumer does not have on hand the card against which he wants the financial transaction to be made. A swap request 114 is sent from the mobile device 102 to the account swapping system 112. The swap request 114 comprises data indicative of the transacting account, being the account that is used to fund the financial transaction. In response to receipt of the swap request 114, an authorisation message 116 is generated by the account swapping system 112 and transmitted to the mobile device 102. The authorisation message 116 may comprise an authorisation code which is then used by the consumer together with the supplied payment card to initiate the transaction at the merchant device 104. The authorisation code may be a one-time password (OTP) with limited time validity of, for example, 5 minutes. The authorisation code may be one or more alphanumeric characters, for example a 4-digit or a 6-digit number.

In an alternate embodiment, the authorisation code may be generated by a mobile application in the mobile device 102 and included in the swap request 114 sent to the account swapping system 112. The authorisation message 116 may include an acknowledgement message indicating receipt of the authorisation code generated by the mobile device 102. The account swapping system 112 may be capable of storing card account information in a linked database (not shown). Examples of card account information stored may include the payment card number, and associated personal identification number (PIN). The card account information may be stored in encrypted format on the database compliant with Payment Card Industry Payment Application Data Security Standard (PCI PA-DSS).

As mentioned above, the financial transaction is initiated at the merchant device 104 through use of the supplied payment card and the authorisation code. For example, the financial transaction may be initiated by the consumer swiping the supplied payment card at the merchant device 104, and entering the OTP on the merchant device 104 in place of the PIN of the supplied payment card. Accordingly, a transaction request 118 which comprises the data indicative of the supplied card account and the authorisation code is generated by the merchant device 104 and transmitted to the acquirer server 106. The supplied card account serves as a placeholder for the transacting card account. In other words, the data indicative of the supplied card account will be replaced by the data indicative of the transacting card account. The transaction request 118 may be compliant with ISO 8583 standard and comprises data elements (DE) which carry the transaction information. The transaction request 118 would be similar to normal transaction requests, with the exception of specific data elements such as a DE 52 value, which carries the authorisation code instead of a verification code e.g. PIN, used to authenticate the supplied payment card. Thus, the present invention may be advantageously implemented on existing merchant devices 104 without modification to existing software/hardware. The transaction request 118 is received by the acquirer server 106, processed similarly to normal transaction requests and subsequently transmitted to the account swapping system 112 for authorisation.

Consider the first embodiment of the invention, where the account swapping system 112 is a single computing device. The transaction request 118 is received by the account swapping system 112. Upon receipt, the transaction request 118 is processed and verified by the account swapping system 112. The account swapping system 112 may verify the transaction request 118 by determining if the authorisation code received with the transaction request 118 matches the authorisation code generated by the account swapping system 112. Upon successful verification, the account swapping system 112 swaps the data indicative of the supplied card account in transaction request 118 with data indicative of the transacting card account that is designated in the swap request 114. For example, if the transaction request 118 is compliant with ISO 8583 standard, at least the DE 52 value of transaction request 118, which carries the authorisation code (e.g. OTP block) is replaced by the card account swapping server 110 with the PIN block of the transacting card account. Further, a DE 2 value of the transaction request 118, which carries the primary account number (PAN) block of the supplied card account, is replaced with the PAN block of the transacting card account. The transaction request 118 is hence modified into transaction request 120, which comprises data indicative of the transacting card account. The transaction request 118 is forwarded by the account swapping system 112 to transacting card issuer server 122 to effect the transfer of funds.

Consider the second embodiment of the invention where the account swapping system 112 is realised by the payment network server 108 and the card account swapping server 110. The transaction request 118 is received by the payment network server 108, and is subsequently analysed for presence of the authorisation code. The authorisation code is indicative that the supplied card account is to be replaced with the transacting card account used for funding the financial transaction in that detection of the authorisation code will cause the payment network server 108 to realise that the transaction request 118 is to be transmitted to the card account swapping server to perform the replacement. In response to the presence of the authorisation code, the received request 118 is then transmitted to the card account swapping server 110. The card account swapping server 110 replaces the data indicative of the supplied card account in transaction request 118 with the data indicative of the transacting card account. In other words, the transaction request 118 is modified into transaction request 120 which comprises data indicative of the transacting card account. The modified transaction request 118, now known as the transaction request 120 is then forwarded to the payment network server 108 and routed to the transacting card issuer server 122 to effect the transfer of funds.

In yet another alternate embodiment, the authorisation code is generated by the card account swapping server 110 (also known as the mobile application server) in response to receiving the swap request 114 generated by the mobile application in the mobile device 102. Upon receipt of swap request 114, the card account swapping server 110 may then send a standby request (not shown) to the payment network server 108. The payment network server 108 records the standby request, and waits for a specific duration for the transaction request 118. The time duration may be, for example, 5 minutes. The standby request may comprise data indicative of the transacting card account and/or data indicative of the supplied card account. The standby request may also comprise data indicative of other card accounts which are accessible in the mobile application. In this alternate embodiment, the transaction request 118 may be received by the payment network server 108 within the time duration and routed to the card account swapping server 110 based on the received standby request. The transaction request 118 is then routed to the card account swapping server 110, which subsequently modifies the request 118 to transaction request 120. In a different implementation of the same embodiment, the transaction request 118 may also be routed based on the presence of the data indicative of the supplied card account e.g. PAN block of the supplied card account. For example, the payment network server 108 may be linked to a database (not shown) which stores at least the data indicative of the received card account. Further, the database may store the standby request (not shown) comprising at least the data indicative of the supplied card account sent from the card account swapping server 110. Upon receipt of the transaction request 118, the transaction request 118 is analysed for presence of the data indicative of the supplied card account. If, for example, the PAN block within the transaction request 118 matches the PAN block of a card account within the standby request, the transaction request 118 is then routed to the card account swapping server 110, which subsequently modifies the request 118 by replacing the data indicative of the supplied card account with the data indicative of the transacting card account identified in the swap request 114 generated by the mobile application in the mobile device 102. The transaction request 120 then contains data indicative of the transacting card account identified by the user through the mobile application.

The transaction request 120 is received by the transacting card issuer server 122. The issuer server 122 records and analyses the transaction request 120. The issuer server 122 may determine, through a linked database and/or server (not shown) if the transaction request 120 should be authorised. For example, the issuer server 122 may confirm if there are sufficient funds in the credit line of the transacting card account. An authorisation message 124 is generated once it is determined that the transaction request is approved. The authorisation message 124, which comprises a message indicative of an authorisation of the transfer of funds at the transacting card account, is transmitted back to the network server 112. For example, the message indicative of an authorisation of the transfer of funds at the transacting card account may be an authorisation response 110/210. Further, the authorisation message may also include a DE 39 value, which carries response code 00, which is indicative of the authorisation of the transfer of funds at the transacting card account.

Upon receipt of the authorisation message 124, in the first embodiment, the account swapping system 112 swaps the data indicative of the transacting card account that is designated in the swap request 114 with data indicative of the supplied card account. For example, if the authorisation message 124 is compliant with ISO 8583 standard, the DE 2 value, which carries the PAN block of the transacting card account, is replaced with the PAN block of the supplied card account. The authorisation message 124 is thus modified into authorisation message 126, which comprises data indicative of the supplied card account. The authorisation message 126 is then transmitted to the acquirer server 106. The acquirer server 106 records and transmits the authorisation message 126 to the merchant device 104.

In the second embodiment (where the account swapping system 112 comprises the payment network server 108 and the card account swapping server 110), the authorisation message 124, which comprises a message indicative of an authorisation of the transfer of funds at the transacting card account, is transmitted to the payment network server 108. The authorisation message 124 is recorded and subsequently routed to the card account swapping server 110 by the payment network server 108. The payment network server 108 swaps the data indicative of the transacting card account with data indicative of the supplied card account, and modifies the authorisation message 124 to the authorisation message 126, which comprises data indicative of the supplied card account and the message indicative of an authorisation of the transfer of funds at the transacting card account. For example, the DE 2 value, which carries the PAN block of the transacting card account, is replaced with the PAN block of the supplied card account. The authorisation message 126 is transmitted back to payment network server 108 and routed to the acquirer server 106. The acquirer server 106 records and transmits the authorisation message 126 to the merchant device 104. The financial transaction is completed once the authorisation message 126 is received by merchant device 104.

As mentioned above, the transaction request 120 is received by the transacting card issuer server 122, which determines if the transaction request 120 should be authorised. If the transaction request 120 is to be refused, a transaction failure message (not shown) indicative of failure to effect the transfer of funds at the transacting card account, is generated. The transaction failure message, which comprises a response code indicative of the failure and the data indicative of the transacting card account, is transmitted back to the account swapping system 112 in the first embodiment, or the payment network server 108 in the second embodiment.

In the first embodiment, the transaction failure message is recorded by the account swapping system 112 which may in turn send a transaction error message (not shown) to mobile device 102 prompting for a selection of an alternate transacting payment card. Further, the account swapping system 112 swaps the data indicative of the transacting card account with data indicative of the supplied card account, and forwards a transaction failure message (not shown) comprising a response code indicative of the failure and the data indicative of the supplied card account to the acquirer server 106. The acquirer server 106 records and routes the transaction failure message to merchant device 104.

In the second embodiment (where the account swapping system 112 comprises the payment network server 108 and the card account swapping server 110), the transaction failure message (not shown), is received by the payment network server 108 and routed to the card account swapping server 110. The card account swapping server 110 may in turn send a transaction error message (not shown) to mobile device 102 prompting for a selection of an alternate transacting payment card. Further, the card account swapping server 110 may modify the transaction failure message by swapping the data indicative of the transacting card account with data indicative of the supplied card account, and forward a transaction failure message (not shown) comprising a response code indicative of the failure and the data indicative of the supplied card account to the payment network server 108. The payment network server 108 records and routes the transaction failure message to acquirer server 106 which in turn transmits the transaction failure message to the merchant device 104.

In embodiments of the invention, if the consumer decides against using the transacting card account for the financial transaction after the swap request 114 is generated, or decides against selecting an alternate transacting payment card after receiving the transaction error message, the consumer may choose to use the supplied payment card and a verification code used to authenticate the supplied payment card (e.g. PIN number) instead of the authorisation code sent in the authorisation message 116. The transaction system 100 would then process the financial transaction as a normal transaction. For example, the consumer may choose to swipe the supplied payment card at the merchant device 104, and enter the PIN number used to authenticate the supplied payment card instead of the generated one-time password (OTP). The merchant device 102 then generates and transmits a transaction request 128 to the acquirer server 106 (not shown). The transaction request 128 comprises the data indicative of the supplied card account and the verification code used to authenticate the supplied card account. The acquirer server 106 records and routes the transaction request 128 to the account swapping system 112. The account swapping system 112 in turn transmits the transaction request 128 to a supplied card issuer server 130.

The supplied card issuer server 130 processes the transaction request 128, and in turn, generates and transmits a message 132 back to the account swapping system 112. The message 132 comprises the data indicative of the supplied card account and may also include either a message indicative of an authorisation of the transfer of funds at the supplied card account or a transaction failure message including a response code indicative a reason for the transaction failure. The account swapping system 112 then transmits message 132 back to the acquirer server 106 which in turn routes the message 132 to the merchant device 104, thus completing the financial transaction.

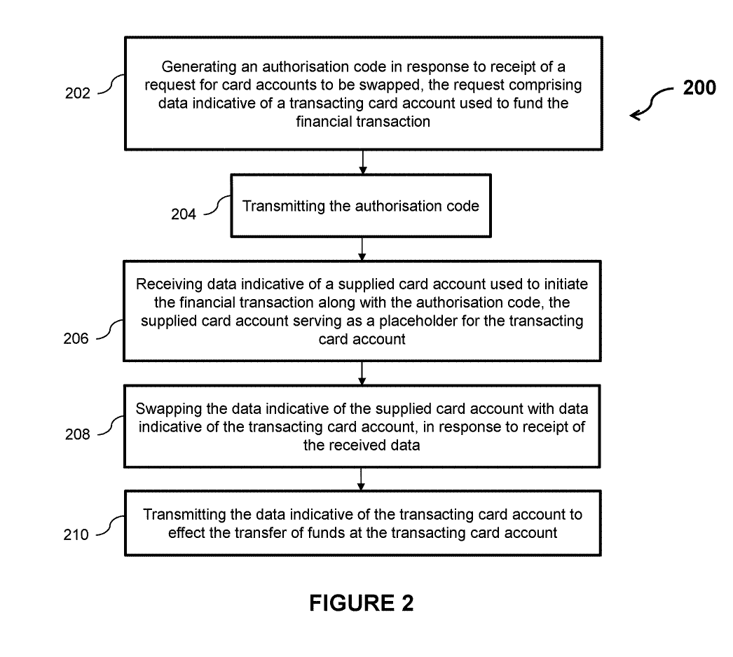

FIG. 2 shows a flowchart 200 illustrating a method of swapping card accounts used in a financial transaction in accordance with a first embodiment of the invention. The method of swapping card accounts used in a financial transaction includes steps 202, 204, 206, 208, and 210.

At step 202, an authorisation code is generated in response to receipt of a request for card accounts to be swapped, the request comprising data indicative of a transacting card account used to fund the financial transaction. At the step 204, the authorisation code is transmitted. At step 206, data indicative of a supplied card account used to initiate the financial transaction is received along with the authorisation code, the supplied card account serving as a placeholder for the transacting card account. At step 208, the data indicative of the supplied card account is swapped with data indicative of the transacting card account, in response to receipt of the received data. At step 210, the data indicative of the transacting card account is transmitted to effect the transfer of funds at the transacting card account.

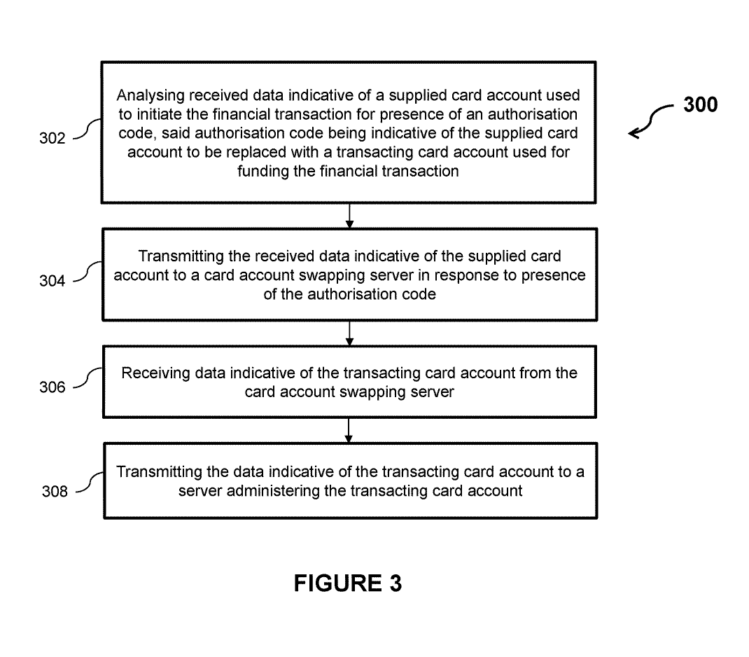

FIG. 3 shows a flowchart 300 illustrating a method of facilitating the swapping of card accounts used in a financial transaction in accordance with a second embodiment of the invention. The facilitating the swapping of card accounts used in a financial transaction includes steps 302, 304, 306 and 308.

At the step 302, received data indicative of a supplied card account used to initiate the financial transaction is analysed for presence of an authorisation code, the authorisation code being indicative of the supplied card account to be replaced with a transacting card account used for funding the financial transaction. At step 304, the received data indicative of the supplied card account is transmitted to a card account swapping server in response to presence of the authorisation code. At step 306, data indicative of the transacting card account is received from the card account swapping server. At step 308, data indicative of the transacting card account is transmitted to a server administering the transacting card account.

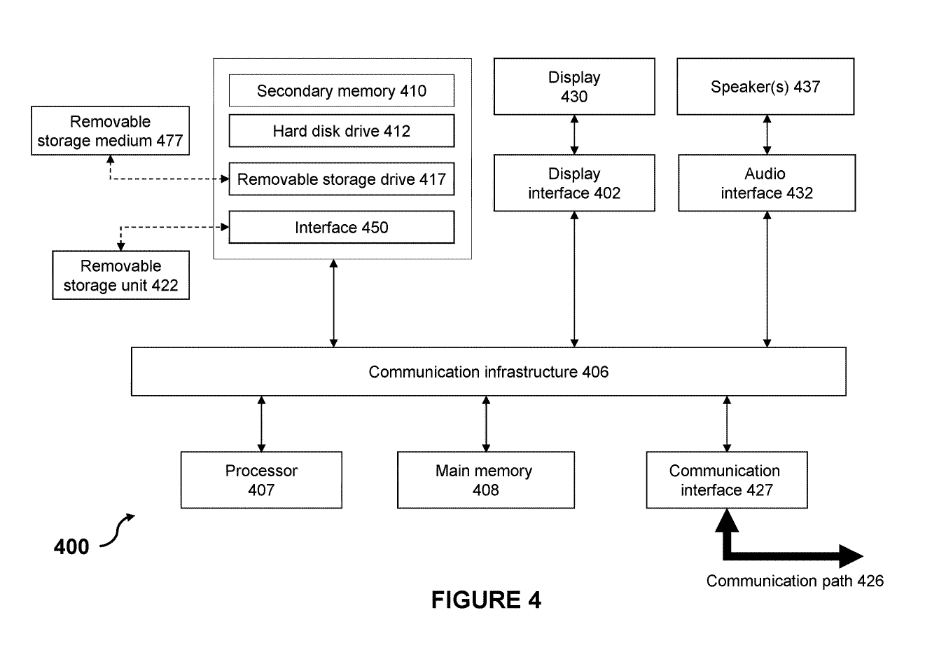

FIG. 4 depicts an exemplary computing device 400, hereinafter interchangeably referred to as a computer system 400, where one or more such computing devices 400 may be used to execute the method of FIGS. 2 and 3. The exemplary computing device 400 can be used to implement the transaction system 100 shown in FIG. 1. The following description of the computing device 400 is provided by way of example only and is not intended to be limiting.

As shown in FIG. 4, the example computing device 400 includes a processor 407 for executing software routines. Although a single processor is shown for the sake of clarity, the computing device 400 may also include a multi-processor system. The processor 407 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 417, which may include a magnetic tape drive, an optical disk drive, a solid state storage drive (such as a USB flash drive, a flash memory device, a solid state drive or a memory card), or the like. The removable storage drive 417 reads from and/or writes to a removable storage medium 477 in a well-known manner. The removable storage medium 477 may include magnetic tape, optical disk, non-volatile memory storage medium, or the like, which is read by and written to by removable storage drive 417. As will be appreciated by persons skilled in the relevant art(s), the removable storage medium 477 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 450. Examples of a removable storage unit 422 and interface 450 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 450 which allow software and data to be transferred from the removable storage unit 422 to the computer system 400.

The computing device 400 also includes at least one communication interface 427. The communication interface 427 allows software and data to be transferred between computing device 400 and external devices via a communication path 426. In various embodiments of the inventions, the communication interface 427 permits data to be transferred between the computing device 400 and a data communication network, such as a public data or private data communication network. The communication interface 427 may be used to exchange data between different computing devices 400 which such computing devices 400 form part an interconnected computer network. Examples of a communication interface 427 can include a modem, a network interface (such as an Ethernet card), a communication port (such as a serial, parallel, printer, GPIB, IEEE 1394, RJ45, USB), an antenna with associated circuitry and the like. The communication interface 427 may be wired or may be wireless. Software and data transferred via the communication interface 427 are in the form of signals which can be electronic, electromagnetic, optical or other signals capable of being received by communication interface 427. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 437.

As used herein, the term “computer program product” may refer, in part, to removable storage medium 477, removable storage unit 422, a hard disk installed in storage drive 412, or a carrier wave carrying software over communication path 426 (wireless link or cable) to communication interface 427. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 427. Such computer programs, when executed, enable the computing device 400 to perform one or more features of embodiments discussed herein. In various embodiments, the computer programs, when executed, enable the processor 307 to perform features of the above-described embodiments. Accordingly, such computer programs represent controllers of the computer system 400.

Software may be stored in a computer program product and loaded into the computing device 400 using the removable storage drive 417, the storage drive 412, or the interface 450. The computer program product may be a non-transitory computer readable medium. Alternatively, the computer program product may be downloaded to the computer system 400 over the communications path 426. The software, when executed by the processor 407, causes the computing device 400 to perform the necessary operations to execute the method 200 and 300 as shown in FIGS. 1 and 2 respectively.

It is to be understood that the embodiment of FIG. 4 is presented merely by way of example to explain the operation and structure of the transaction system 100. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the various functions and operations of the servers as described in the above embodiments.

When used to realise the account swapping system 112 of FIG. 1, which is configured to administer the swapping of card accounts used in a financial transaction, the processor 407 and computer program code stored in the memory 408 are configured to cause the network server 112 (i.e. the account swapping system) to generate an authorisation code in response to receipt of a request for card accounts to be swapped, the request comprising data indicative of a transacting card account used for the financial transaction. The processor 407 and computer program code stored in the memory 408 are further configured to transmit the authorisation code and receive data indicative of a supplied card account used to initiate the financial transaction along with the authorisation code, the supplied card account serving as a placeholder for the transacting card account. The processor 407 and computer program code stored in the memory 408 are further configured to swap the data indicative of the supplied card account with data indicative of the transacting card account, in response to receipt of the received data, and transmit the data indicative of the transacting card account to effect the transfer of funds at the transacting card account.

When used to realise the payment network server 108 of FIG. 1, which is configured to facilitate the swapping of card accounts used in a financial transaction, the processor 407 and computer program code stored in the memory 408 are configured to cause the payment network server 108 (i.e. the payment network system) to analyse received data indicative of a supplied card account used to initiate the financial transaction for presence of an authorisation code, said authorisation code being indicative of the supplied card account to be replaced with a transacting card account used for the financial transaction. The processor 407 and computer program code stored in the memory 408 are also configured to transmit the received data indicative of the supplied card account to a card account swapping server in response to presence of the authorisation code and receive data indicative of the transacting card account from the card account swapping server. The processor 407 and computer program code stored in the memory 408 are further configured to transmit the data indicative of the transacting card account to a server administering the transacting card account.

When the computing device 400 is configured to realise the account swapping system 112 to administer the swapping of card accounts used in a financial transaction, the account swapping system 112 will have a non-transitory computer readable medium having stored thereon an application which when executed, causes the account swapping system 112 to perform steps comprising a) generating an authorisation code in response to receipt of a request for card accounts to be swapped, the request comprising data indicative of a transacting card account used for the financial transaction; b) transmitting the authorisation code; c) receiving data indicative of a supplied card account used to initiate the financial transaction along with the authorisation code, the supplied card account serving as a placeholder for the transacting card account; d) swapping the data indicative of the supplied card account with data indicative of the transacting card account, in response to receipt of the received data; and e) transmitting the data indicative of the transacting card account to effect the transfer of funds at the transacting card account.

Further, the computing device 400 when configured to realise the payment network server 108 of FIG. 1 will have a non-transitory computer readable medium having stored thereon an application which when executed, causes the payment network server 108 to perform steps comprising a) analysing received data indicative of a supplied card account used to initiate the financial transaction for presence of an authorisation code, said authorisation code being indicative of the supplied card account to be replaced with a transacting card account used for the financial transaction; b) transmitting the received data indicative of the supplied card account to a card account swapping server in response to presence of the authorisation code; c) receiving data indicative of the transacting card account from the card account swapping server; and d) transmitting the data indicative of the transacting card account to a server administering the transacting card account.

By swapping card accounts used in a financial transaction, consumers would be able to use transacting card accounts different from that of a supplied card account at a transaction terminal. Advantageously, this allows consumers access to one or more card accounts while using a single payment card and grants consumer flexibility in using different card accounts for various types of transactions with a single payment card. Accordingly, consumers would be able to use transacting accounts which is associated with payment cards that are not presently on hand, or use payment cards that has reached a credit limit, or has zero debit balance at a transaction terminal.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of swapping card accounts used in a financial transaction, the method comprising:
generating an authorisation code in response to receipt of a request for card accounts to be swapped, the request comprising data indicative of a transacting card account used to fund the financial transaction;
transmitting the authorisation code;
receiving data indicative of a supplied card account used to initiate the financial transaction along with the authorisation code, the supplied card account serving as a placeholder for the transacting card account;
swapping the data indicative of the supplied card account with data indicative of the transacting card account, in response to receipt of the received data; and
transmitting the data indicative of the transacting card account to effect the transfer of funds at the transacting card account.

2. The method of claim 1, further comprising the steps of:
receiving a message indicative of an authorisation of the transfer of funds at the transacting card account; and
forwarding the message indicative of the authorisation of the transfer of funds at the transacting card account together with data indicative of the supplied card account.

3. The method of claim 1, wherein the supplied card account and the transacting card account belong to a plurality of card accounts accessible in a mobile application to which the authorisation code is transmitted.

4. The method of claim 1, wherein receiving the data indicative of the supplied card account used to initiate the financial transaction comprises receiving a verification code used to authenticate the supplied card account.

5. The method of claim 4, wherein the swapping of the data and the transmission of the data indicative of the transacting card account to effect the transfer of funds at the transacting card account occurs after successful verification of the authorisation code and wherein unsuccessful verification of the authorisation code results in the method further comprising:
determining if the verification code is received; and
transmitting the data indicative of the supplied card account to effect the transfer of funds at the supplied card account in response to receipt of the verification code.

6. The method of claim 1, wherein the transfer of funds at the transacting card account comprises crediting or debiting of the transacting card account.

7. The method of claim 1, wherein the step of generating the authorisation code, the step of transmitting the authorisation code and the step of swapping the data indicative of the supplied card account with the data indicative of the transacting card account are performed by a payment network server.

8. The method of claim 1, wherein the step of generating the authorisation code, the step of transmitting the authorisation code and the step of swapping the data indicative of the supplied card account with the data indicative of the transacting card account are performed by a card account swapping server.

9. The method of claim 1, further comprising the steps of:
transmitting a message indicative of failure to effect the transfer of funds at the transacting card account; and
prompting for a selection of an alternate transacting card account.

10. A method of facilitating the swapping of card accounts used in a financial transaction, the method comprising:
analysing received data indicative of a supplied card account used to initiate the financial transaction for presence of an authorisation code, said authorisation code being indicative of the supplied card account to be replaced with a transacting card account used for funding the financial transaction;
transmitting the received data indicative of the supplied card account to a card account swapping server in response to presence of the authorisation code;
receiving data indicative of the transacting card account from the card account swapping server; and
transmitting the data indicative of the transacting card account to a server administering the transacting card account.

11. The method of claim 10, further comprising the steps of:
receiving, from the server administering the transacting card account, a message indicative of an authorisation of the transfer of funds at the transacting card account; and
forwarding, to an acquirer from which the data indicative of the supplied card account used to initiate the financial transaction is received, the message indicative of the authorisation of the transfer of funds at the transacting card account together with data indicative of the supplied card account.

12. The method of claim 10, wherein analysing received data indicative of the supplied card account used to initiate the financial transaction comprises receiving a verification code used to authenticate the supplied card account.

13. The method of claim 12, wherein the transmission of the received data indicative of the supplied card account to the card account swapping server occurs after successful verification of the authorisation code, and wherein unsuccessful verification of the authorisation code results in the method further comprising:
determining if the verification code is received; and
transmitting the data indicative of the supplied card account to effect the transfer of funds at the supplied card account in response to receipt of the verification code.

14. The method of claim 11, wherein the transfer of funds at the transacting card account comprises crediting or debiting of the transacting card account.

15. The method of claim 10, further comprising the steps of:
transmitting a message indicative of failure to effect the transfer of funds at the transacting card account; and
prompting for a selection of another transacting card account.

16. An account swapping system configured to administer the swapping of card accounts used in a financial transaction, the account swapping system comprising:
at least one processor; and
at least one memory including computer program code;
the at least one memory and the computer program code configured to, with the at least one processor, cause the account swapping system at least to:
generate an authorisation code in response to receipt of a request for card accounts to be swapped, the request comprising data indicative of a transacting card account used to fund the financial transaction;
transmit the authorisation code;
receive data indicative of a supplied card account used to initiate the financial transaction along with the authorisation code, the supplied card account serving as a placeholder for the transacting card account;
swap the data indicative of the supplied card account with data indicative of the transacting card account, in response to receipt of the received data; and
transmit the data indicative of the transacting card account to effect the transfer of funds at the transacting card account.

17. The account swapping system of claim 16, wherein the account swapping system is further configured to:
receive a message indicative of an authorisation of the transfer of funds at the transacting card account; and
forward the message indicative of the authorisation of the transfer of funds at the transacting card account together with data indicative of the supplied card account.

18. The account swapping system of claim 16, wherein the account swapping system is further configured to receive a verification code used to authenticate the supplied card account.

19. The account swapping system of claim 18, wherein the account swapping system is configured to swap the received data indicative of the supplied card account with the data indicative of the transacting card account and transmit the data indicative of the transacting card account after successful verification of the authorisation code, and wherein upon unsuccessful verification of the authorisation code, the account swapping system is further configured to:
determine if the verification code is received; and
transmit the data indicative of the supplied card account to effect the transfer of funds at the supplied card account in response to receipt of the verification code.

20. A payment network server configured to facilitate the swapping of card accounts used in a financial transaction, the payment network server comprising:
at least one processor; and
at least one memory including computer program code;
the at least one memory and the computer program code configured to, with the at least one processor, cause the payment network server at least to:
analyse received data indicative of a supplied card account used to initiate the financial transaction for presence of an authorisation code, said authorisation code being indicative of the supplied card account to be replaced with a transacting card account used to fund the financial transaction;
transmit the received data indicative of the supplied card account to a card account swapping server in response to presence of the authorisation code;
receive data indicative of the transacting card account from the card account swapping server; and
transmit the data indicative of the transacting card account to a server administering the transacting card account.

21. The payment network server of claim 20, wherein the payment network server is further configured to:
receive, from the server administering the transacting card account, a message indicative of an authorisation of the transfer of funds at the transacting card account; and
forward, to an acquirer from which the data indicative of the supplied card account used to initiate the financial transaction is received, the message indicative of the authorisation of the transfer of funds at the transacting card account together with data indicative of the supplied card account.

22. The payment network server of claim 20, wherein the payment network server is configured to receive a verification code used to authenticate the supplied card account.

23. The payment network server of claim 22, wherein the payment network server is configured to transmit the data indicative of the transacting card account after successful verification of the authorisation code, and wherein upon unsuccessful verification of the authorisation code, the payment network is further configured to:
determine if the verification code is received; and
transmit the data indicative of the supplied card account to effect the transfer of funds at the supplied card account in response to receipt of the verification code.

24. A non-transitory computer readable medium having stored thereon an application which when executed by a computer causes the computer to perform steps comprising:
generating an authorisation code in response to receipt of a request for card accounts to be swapped, the request comprising data indicative of a transacting card account used to fund the financial transaction;
transmitting the authorisation code;
receiving data indicative of a supplied card account used to initiate the financial transaction along with the authorisation code, the supplied card account serving as a placeholder for the transacting card account;
swapping the data indicative of the supplied card account with data indicative of the transacting card account, in response to receipt of the received data; and
transmitting the data indicative of the transacting card account to effect the transfer of funds at the transacting card account.
